(19) United States
(12) Patent Application Publication
(10) Pub. No.: US 2023/0320930 A1
(43) Pub. Date: Oct. 12, 2023

(54) INFLATABLE ICE BATH

(71) Applicant: Tru Grit Fitness LLC, Vista, CA (US)

(72) Inventors: Brandon Hearn, Vista, CA (US); Matt Piva, Vista, CA (US)

(21) Appl. No.: 17/719,206

(22) Filed: Apr. 12, 2022

(51) Int. Cl. A61H 33/00; B29D 22/02

(52) U.S. Cl. CPC A61H 33/6005; B29D 22/02; B29K 2623/083; A61H 2201/0214; A61H 2201/0103

(57) ABSTRACT

An inflatable pool includes a floor panel and an inflatable wall coupled to the floor panel. The inflatable wall includes an inner panel, an outer panel coupled to the inner panel to define a wall enclosure, and a plurality of threads, with each thread being connected to the inner panel and the outer panel and extending through the wall enclosure. The inflatable wall is configured to transition between a deflated configuration and an inflated configuration, with the volume of the wall enclosure increasing as the inflatable wall transitions from the deflated configuration toward the inflated configuration. The inflatable pool additionally includes an inflation valve extending into the wall enclosure to facilitate inflation of the wall enclosure. At least one valve extends through the inflatable wall to facilitate fluid communication through the inflatable wall through a passageway fluidly isolated from the wall enclosure.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to an inflatable pool, and more specifically, to an inflatable structure having sufficient structural rigidity when inflated for use as an ice bath.

### 2. Description of the Related Art

Ice baths or cold-water immersion is a common recovery technique used by athletes, particularly following periods of intense athletic activity. When using an ice bath, an individual immerses a substantial part of their body in a bath of ice or ice-water for a period of time (e.g., typically no more than 10-15 minutes). The cold temperature of the ice bath helps to speed body recovery, as well as reduce muscle pain and soreness, by causing blood vessels to constrict, which may reduce inflammation, swelling, or other reactions in the body. After spending time in the cold temperature water, the individual gets out of the bath and upon leaving the cold temperature, the individuals blood vessels may open up and may begin flushing away metabolic waste from the workout.

Many individuals prepare their own ice bath using a tub located in their home. They may purchase bags of ice from a local store and dump the ice in the tub and mix with water. As an alternative to an existing tub inside the individual's home, a child's outdoor tub may be used if there is sufficient depth to accommodate the desired therapy of the user, either inside or outside.

In addition to the conventional tub structures described above, more specific ice bath structures have been developed in view of the growing popularity in ice bath therapy. The at-home ice baths may be capable of use both inside and outside, and may have refrigeration capabilities, as well as a thermostat that allows for programmable temperature control.

Conventional, in-home tubs, as well as specialized at-home ice baths may enable ice bath therapy at the individual's home. However, such tubs and baths may be limited in their ability to be used outside of the individual's home. For instance, if an individual were to go on vacation or visit with friends or family, there may not be a tub or bath available for the desired therapy.

Accordingly, there is a need in the art for an ice bath particularly suitable for travel, without compromising the functionalities of the ice bath. Various aspects of the present disclosure address this particular need, as will be discussed in more detail below.

### BRIEF SUMMARY

In accordance with one embodiment of the present disclosure, there is provided an inflatable pool comprising a floor panel and an inflatable wall coupled to the floor panel. The inflatable wall includes an inner panel, an outer panel coupled to the inner panel to define a wall enclosure, and a plurality of threads, with each thread being connected to the inner panel and the outer panel and extending through the wall enclosure. The inflatable wall is configured to transition between a deflated configuration and an inflated configuration, with the volume of the wall enclosure increasing as the inflatable wall transitions from the deflated configuration toward the inflated configuration. The inflatable pool additionally includes an inflation valve extending into the wall enclosure to facilitate inflation of the wall enclosure. At least one valve extends through the inflatable wall to facilitate fluid communication through the inflatable wall through a passageway fluidly isolated from the wall enclosure.

The plurality of threads may be configured to be disposable in tension when the inflatable wall is in the inflated configuration. The plurality of threads may also be configured such that tension in the plurality of threads may be reduced as the inflatable wall transitions from the inflated configuration toward the deflated configuration.

The inflatable wall may include at least one incision extending from the inner panel toward the outer panel, with the incision being configured to facilitate formation of a rounded portion of the inflatable wall. The inflatable pool may include a connector strip extending over a respective one of the at least one incision.

The inflatable wall may include a first panel having an outer edge coupled to the outer panel and an inner edge coupled to the inner panel. The inflatable wall may also include a second panel having an outer edge coupled to the outer panel adjacent the outer edge of the first panel, and an inner edge coupled to the inner panel. The first and second panels may be selectively transitional between an open position and a closed position. In the open position, the outer edges of the first and second panels may be moved closer together as the first and second panels transition from the open position toward the closed position. The outer edges of the first and second panels may be spaced apart by 3-8 cm when the first and second panels are in the open position.

The at least one valve may include a pair of valves including a fill valve and a drain valve.

The inflatable pool may additionally include a lower panel connected to the inner panel and the outer panel and partially defining the wall enclosure. The inflatable pool may also include an upper panel connected to the inner panel and the outer panel in opposed relation to the lower panel, with the upper panel at least partially defining the wall enclosure.

The floor panel may include a pad formed of a polymer material.

The inflatable wall may be configured to have a pair of opposed arcuate end portions when in the inflated configuration.

According to another embodiment, there is provided an inflatable pool including a floor panel and a sidewall connected to the floor panel and being formed of a drop stitch material having a plurality of internal structural support members. The sidewall is transitional between an inflated configuration and a deflated configuration, with a volume of the sidewall increasing and the plurality of internal structural support members being disposed in tension as the sidewall transitions from the deflated configuration toward the inflated configuration. The sidewall and the floor panel may define a pool reservoir when the sidewall is in the inflated configuration. The inflatable pool may additionally include an inlet valve extending through the sidewall and in communication with the pool reservoir, and an outlet valve extending through the sidewall an in communication with the pool reservoir. The inlet valve and the outlet valve may be operable in concert with each other to achieve a prescribed circulation through the pool reservoir and/or the rapid filling and draining of water from the pool.

According to another embodiment, there is provided a method of forming an inflatable pool, the method comprising the step of forming at least two voids in a panel assembly including an inner panel, an outer panel opposite the inner panel and defining an enclosure therebetween, and a plurality of threads, with each thread being connected to the inner panel and the outer panel. Each void is formed at least in the inner panel. The method additionally includes integrating an inflation valve extending into the panel assembly and integrating at least one valve extending through the panel assembly. Furthermore, the panel assembly is formed into a sidewall having a pair of straight portions and a pair of opposing rounded portions. Each rounded portion is formed by closing one of the at least two voids. The sidewall is inflatable and is configured to transition between a deflated configuration and an inflated configuration, with the volume of the enclosure increasing as the sidewall transitions from the deflated configuration toward the inflated configuration.

The method may include the step of applying a connecting strip to the panel assembly after the void has been closed, with the connecting strip extending over the collapsed void to mitigate opening of the void.

The method may also include the step of connecting a floor panel to the sidewall.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of an ice bath with an individual resting in the ice bath depicted in phantom;

FIG. 2 is a top, cross sectional view of the ice bath depicted in FIG. 1;

FIG. 3 is a partial cross sectional view of a section of the ice bath prior to being formed into a rounded shape;

FIG. 4 is a partial, top cross sectional view, of the section depicted in FIG. 3 after having been formed into the rounded shape;

FIG. 5 is an end, cross sectional view of the ice bath; and

FIG. 6 is an enlarged cross sectional view of a portion of FIG. 5.

Common reference numerals are used throughout the drawings and the detailed description to indicate the same elements.

### DETAILED DESCRIPTION

The detailed description set forth below in connection with the appended drawings is intended as a description of certain embodiments of an inflatable ice bath and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to an inflatable ice bath (e.g., an inflatable pool) that may be configured to be selectively inflated during use or deflated during periods of non-use. The inflation or deflation may be achieved with the use of an electronic pump or non-electric pump (e.g., a hand pump or foot pump). The ice bath may be configured to achieve a semi-rigid form when inflated to support the weight of an ice-water mixture, as well as the weight of an individual bathing in the ice bath. The rigidity may be attained through the use of a drop stitch material having a plurality of internal threads that help maintain the shape of the ice bath when the ice bath is inflated. The ability to deflate the ice bath allows the ice bath to be placed in a compact configuration for ease in storage and transport. Thus, the ice bath may be set up and deployed in almost any location, and thus, a user may enjoy ice bath therapy at home or on vacation.

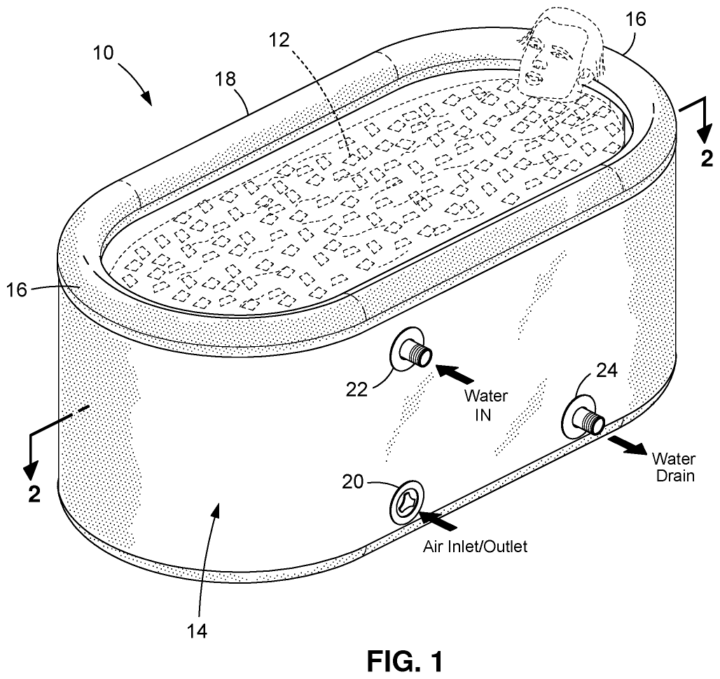

Referring now specifically to FIG. 1, there is depicted ice bath 10 in an inflated configuration, with a mixture 12 of water and ice being depicted in phantom, along with a user submerged in the ice bath 10 from the neck down. The ice bath 10 includes an inflatable sidewall 14 extending upwardly from a floor panel to define an ice bath depth when inflated. The shape of the sidewall 14 may be generally oval or elliptical, with two rounded end portions 16 and a pair of generally straight portions 18 extending between the rounded end portions 16 in generally parallel relation to each other. The upper surface of the sidewall 14 may be rounded, which may be a comfortable surface for a user to rest his or her head when bathing in the ice bath 10. The ice bath 10 may include several valves formed within the sidewall 14, such as an air inlet/outlet valve 20, a water in valve 22, and a water drain valve 24, which will be described in more detail below.

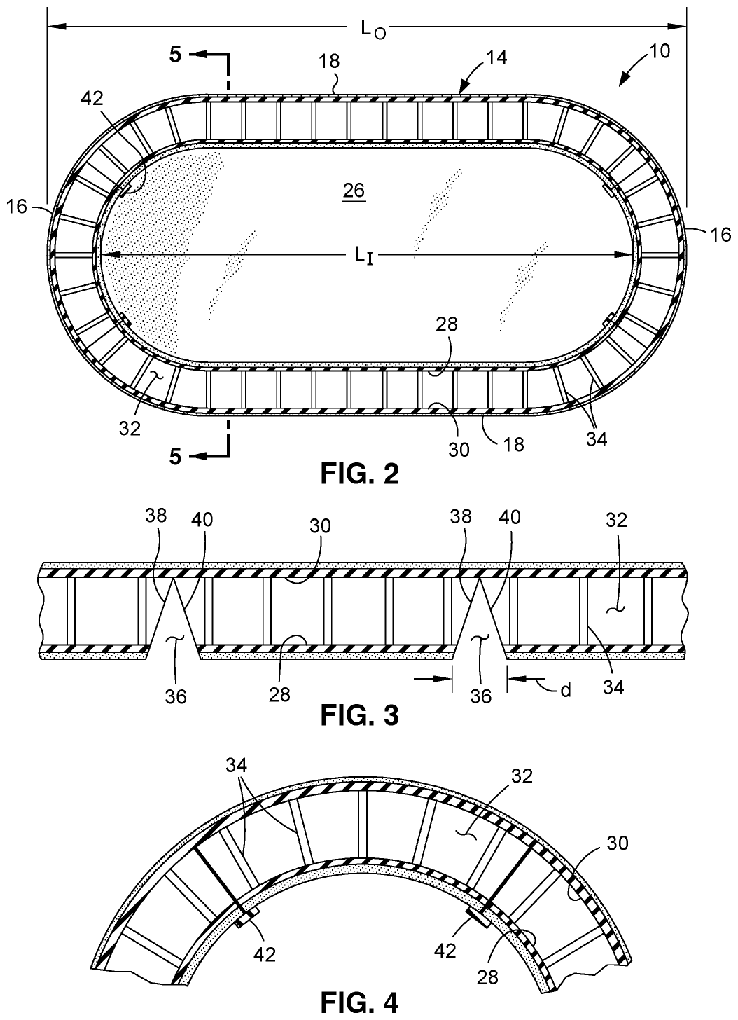

FIG. 2 is a top, cross sectional view of the ice bath 10 without the mixture 12 of ice and water, with the cross section allowing for an internal view of the sidewall 14. The top view also illustrates a floor panel 26, which is sized to extend across the bottom of the ice bath 10, with the periphery of the floor panel 26 being attached to a lower end portion of the sidewall 14. The sidewall 14 and the floor panel 26 may collectively define a reservoir 28 which may be sized to retain the mixture 12 of ice and water, as well as provide a space for the user to sit or lie when bathing in the ice bath 10.

According to one embodiment, the inflatable sidewall 14 may be formed of a drop stitch material (which may also be known as wire drawing cloth), which may generally have the structural arrangement depicted in FIG. 2. In this regard, a drop stitch formed sidewall 14 may include an inner panel 28 and an outer panel 30 positioned outwardly relative to the inner panel 28 to define a wall enclosure 32, which may refer to the space within the sidewall 14 between the inner panel 28 and the outer panel 30. The inner and outer panels 28, 30 may be formed from polyvinyl chloride (PVC) or other suitable materials known by those skilled in the art. A plurality of threads 34 may be located within the sidewall 14, with each thread 34 being connected to the inner panel 28 and the outer panel 30 and extending through the wall enclosure 32. As will be explained in more detail below, the plurality of threads 34 may be configured to be disposable in tension when the inflatable wall 14 is in the inflated configuration. The plurality of threads 34 may also be configured such that tension in the plurality of threads 34 may be reduced as the inflatable wall 14 transitions from the inflated configuration toward the deflated configuration.

Further description of drop stitch materials or fabrics is disclosed in the attached appendix, as well as U.S. Patent Application Publication No. 2019/0015624 entitled INFLATABLE FLOAT TANK, the contents of both of which are expressly incorporated herein by reference.

Referring now to FIGS. 3 and 4, the curvature of the sidewall 14 shown in FIGS. 1 and 2 may be achieved by using a generally planar or straight panel assembly (i.e., the inner panel 28, outer panel 30, and threads 34), and configuring the panel assembly to facilitate formation of the bend or curvature needed to form the rounded end portions 16. In one embodiment, an incision is formed in the panel assembly, with the incision extending through the inner panel 28, but not through the outer panel 30. The incision may also clear or remove some of the threads 34 extending between the inner panel 28 and the outer panel 30 to form triangular shaped voids 36. When the panel assembly is in the straight or planar configuration depicted in FIG. 3, the triangular shaped voids 36 may have an open end extending through the inner panel 28. The triangular shaped voids 36 may be collapsed or closed during the assembly process to convert the generally flat configuration into a curved configuration, as shown in FIG. 4. As such, the formation of the voids 36 within the panel assembly allows the inner panel 28 to achieve a smaller dimension from the outer panel 30, with the difference in dimension being approximately equal to the collective size of the openings formed in the inner panel 28.

In one embodiment, the inflatable wall 14 may include a first panel 38 having an outer edge coupled to the outer panel 30 and an inner edge coupled to the inner panel 28. The inflatable wall 14 may also include a second panel 40 having an outer edge coupled to the outer panel 30 adjacent the outer edge of the first panel 38, and an inner edge coupled to the inner panel 28. The first and second panels 38, 40 may be selectively transitional between an open position and a closed position. In the open position, the outer edges of the first and second panels 38, 40 may be moved closer together as the first and second panels 38, 40 transition from the open position toward the closed position. The outer edges of the first and second panels 38, 40 may be spaced apart by a distance, d, which may be between 3-8 cm when the first and second panels 38, 40 are in the open position. The first and second panels 38, 40 may include strips of fabric that may extend between the inner and outer panels 28, 30, or alternatively, the first and second panels 38, 40 may more broadly refer to those portions of the inner panel 28 and threads 34 immediately adjacent the voids 36.

When the triangular void 36 is closed to form the curved configuration, a connecting strip 42 may be applied to the sidewall 14 to retain the curved shape. The connecting strip 42 may have an adhesive surface that allows for suitable bonding between the connecting strip 42 and the sidewall 14. In other embodiments, the connecting strip 42 may be welded or otherwise secured to the sidewall 14 to create a fluid-tight seal therebetween.

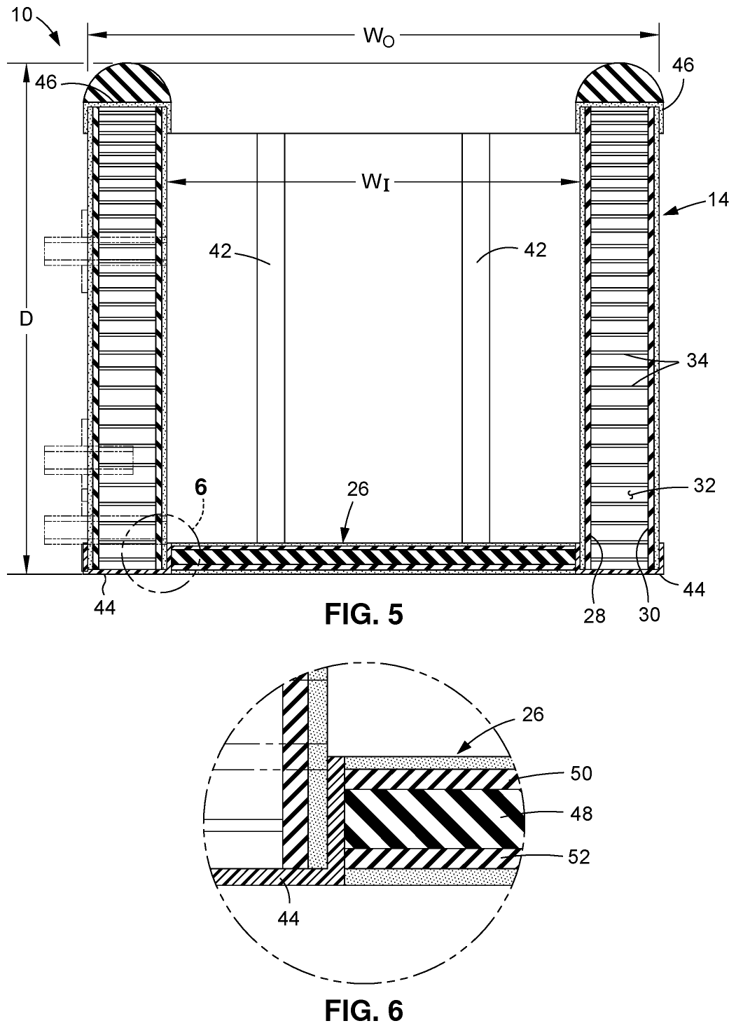

Referring now to FIG. 5, while the inner and outer panels 28, 30 may form the inner and outer portions of the sidewall 14, and thus, the sidewall enclosure 32, the lower portion of the sidewall 14 may include a lower panel 44, while the upper portion of the sidewall 14 may include an upper panel 46. Each of the lower and upper panels 44, 46 may be connected to both the inner panel 28 and the outer panel 30 and partially define the wall enclosure 32. The connection of the lower and upper panels 44, 46 may be secured to the inner and outer panels 28, 30 via adhesive, welding, or via other attachment techniques known in the art which would allow for creation of a fluid tight seal therebetween.

The inflatable wall 14 is configured to transition between a deflated configuration and an inflated configuration, with the volume of the wall enclosure 32 increasing as the inflatable wall transitions from the deflated configuration toward the inflated configuration. When inflated, the ice bath 10 may define a depth, D, an outer width Wo, an inner width WI an outer length Lo, and an inner length Li. In one embodiment, the depth D may be in the range of 18-40 inches, and more specifically approximately 25 inches; the outer width Wo may be in the range of 24-40 inches, and more specifically, approximately 30 inches; the inner width WI may be in the range of 18-30 inches, and more specifically approximately 23 inches, and the outer length Lo may be in the range of 48-90 inches, and more specifically, approximately 60 inches; the inner length Li may be in the range of 41-83 inches, and more specifically approximately 53 inches.

The floor panel 26 may include a pad 48 formed of a polymer material. The pad 48 may be sandwiched between an upper layer 50 and a lower layer 52. The pad 48 may be formed from ethylene-vinyl acetate (EVA), while the upper and lower layers 50, 52 may be formed from PVC. While EVA and PVC may be used in one particular embodiment, other materials known in the art may also be used. Furthermore, the bonding or attachment of the upper and lower layers 50, 52 to the pad 48 may be facilitate by the use of an adhesive or other bonding techniques known in the art.

The ice bath 10 additionally includes an inflation valve 20 extending into the wall enclosure 32 to facilitate inflation of the wall enclosure 32. In this regard, the inflation valve 20 may extend through the outer panel 30, and not the wall enclosure 32 without passing through the inner panel 28. The inflation valve 20 may be configured to be fluidly attached to a pump, such as a hand pump or an electric pump, to facilitate inflation or deflation of the ice bath 10.

The inlet and outlet valves 22, 24 of the ice bath 19 may be used to facilitate rapid filling and draining, respectively, of the ice bath 10. In this regard, the inlet and outlet valves 22, 24 both extend through the sidewall 14 to facilitate fluid communication through the inflatable wall 14 through a passageway fluidly isolated from the wall enclosure 32 (e.g., water does not flow into the wall enclosure 32 to fill the wall enclosure 32). In this regard, the inlet and outlet valves 22, 24 allow the water to pass through the sidewall 14, rather than filling the sidewall 14. The inlet valve 22 may be located at a height that is elevated above the outlet valve 24 when the ice bath 10 is inflated. Both the inlet and outlet valves 22, 24, may include standard ½″ or ¾″ NPT thread coupler, or may be configured to be compatible with a standard NPT thread coupler such as that utilized on conventional garden hoses to aid in the filling and draining by the user. However, valves of different size or configuration may also be used without departing from the spirit and scope of the present disclosure.

According to one embodiment, the inlet valve 22 and the outlet valve 24 may be operable in concert with each other to achieve a prescribed circulation within the ice bath 10. In this regard, the inlet and outlet valves 22, 24 may be connected to a pump to achieve a desired circulation within the ice bath 10. The circulation may achieve a more uniform temperature of the ice/water mixture 23 within the ice bath 10, while also possibly providing a therapeutic massaging feel for the user within the ice bath 10. One or more filters may be built into the outlet valve 24 to prevent ice from being drawn into the pump.

In use, a user may unroll or unfold a deflated ice bath 10 and connect the air inlet/outlet valve 20 to an inflation pump. The user may actuate the pump to cause pressurized air or other fluid to fill the wall enclosure 32. As the wall enclosure 32 becomes inflated, the sidewall 14 extends away from the floor panel 26, with the volume of the enclosure 32 increasing. As the sidewall 14 takes shape, the threads 34 within the sidewall 14 are disposed in tension as they extend between the inner and outer panels 28, 30. The tension in the threads 34 may allow the sidewall 14 to attain a rigidity that is similar to that of wood.

Once inflated, the user may connect a water supply to the water inlet valve 24 to begin filling the ice bath 10. Ice may also be added to achieve a desired mixture 12; however, it is understood that the ice bath 10 may also be used without ice. Along these lines, it is contemplated that a water chiller or refrigeration unit may be connected to the water supply line to chill the water prior to passing into the ice bath 10.

If the user desires to impart a circulation on the water within the ice bath 10, the user may connect a pump to the water drain valve 24 as well as the water in valve 22 to draw water from the water drain valve 24 and recirculate the water through the water in valve 22.

The user may sit or lie within the ice bath for a period of time, such as 10-15 minutes, for the desired ice bath therapy. Upon completing the therapy, the user may drain the water through the water drain valve 24.

After the water has been drained, the ice bath 10 may be rapidly deflated by opening the air inlet/outlet valve 20. A pump may be connected to the air inlet/outlet valve 20 to more quickly deflate the ice bath 10. In this regard, as the sidewall 14 is deflated, the tension in the threads may decrease, and the inner and outer panels 28, 30 may become more flexible. Furthermore, the volume within the enclosure 32 may decrease due to the collapsing of the inner and outer panels 28, 30.

Once the sidewall 14 is completely deflated, the ice bath may be rolled up or folded and then placed in a storage bag or other storage container.

The ability to quickly deploy/inflate, set up, use, deflate and store the ice bath 10 allows for use of the ice bath 10 when the user is away from home, such as on vacation, or visiting a friend's or family's house. To this end, the ice bath is easily stored, transported and inflated and filled with water to be completely portable in use.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice. Further, although the present disclosure is specifically suited and designed for low temperature/ice bath applications, those skilled in the art will recognize that it is additionally suitable for warm water and ambient water bath applications, all of which are contemplated in the spirit of the present disclosure, and the term ice bath will include all water temperature baths.

1. An inflatable pool comprising:
a floor panel;
an inflatable wall coupled to the floor panel and including:
an inner panel;
an outer panel coupled to the inner panel to define a wall enclosure; and
a plurality of threads, each thread being connected to the inner panel and the outer panel and extending through the wall enclosure;
the inflatable wall being configured to transition between a deflated configuration and an inflated configuration, the volume of the wall enclosure increasing as the inflatable wall transitions from the deflated configuration toward the inflated configuration;
an inflation valve extending into the wall enclosure to facilitate inflation of the wall enclosure; and
at least one valve extending through the inflatable wall to facilitate fluid communication through the inflatable wall through a passageway fluidly isolated from the wall enclosure.

2. The inflatable pool recited in claim 1, wherein the plurality of threads are configured to be disposable in tension when the inflatable wall is in the inflated configuration.

3. The inflatable pool recited in claim 1, wherein the plurality of threads are configured such that tension in the plurality of threads is reduced as the inflatable wall transitions from the inflated configuration toward the deflated configuration.

4. The inflatable pool recited in claim 1, wherein the inflatable wall includes at least one incision extending from the inner panel toward the outer panel, the incision being configured to facilitate formation of a rounded portion of the inflatable wall.

5. The inflatable pool recited in claim 4, further comprising a connector strip extending over a respective one of the at least one incision.

6. The inflatable pool recited in claim 1, wherein the inflatable wall includes:
a first panel having an outer edge coupled to the outer panel and an inner edge coupled to the inner panel; and
a second panel having an outer edge coupled to the outer panel adjacent the outer edge of the first panel, and an inner edge coupled to the inner panel;
the first and second panels being selectively transitional between an open position and a closed position, in the open position, the outer edges of the first and second panels being moved closer together as the first and second panels transition from the open position toward the closed position.

7. The inflatable pool recited in claim 6, wherein the outer edges of the first and second panels are spaced apart by 3-8 cm when the first and second panels are in the open position.

8. The inflatable pool recited in claim 1, wherein the at least one valve includes a pair of valves including a fill valve and a drain valve.

9. The inflatable pool recited in claim 1, further comprising a lower panel connected to the inner panel and the outer panel and partially defining the wall enclosure.

10. The inflatable pool recited in claim 9, further comprising an upper panel connected to the inner panel and the outer panel in opposed relation to the lower panel, the upper panel at least partially defining the wall enclosure.

11. The inflatable pool recited in claim 1, wherein the floor panel includes a pad formed of a polymer material.

12. The inflatable pool recited in claim 1, wherein the inflatable wall is configured to have a pair of opposed arcuate end portions when in the inflated configuration.

13. An inflatable pool comprising:
a floor panel;
a sidewall connected to the floor panel and being formed of a drop stitch material having a plurality of internal structural support members, the sidewall being transitional between an inflated configuration and a deflated configuration, a volume of the sidewall increasing and the plurality of internal structural support members being disposed in tension as the sidewall transitions from the deflated configuration toward the inflated configuration, the sidewall and the floor panel defining a pool reservoir when the sidewall is in the inflated configuration;
an inlet valve extending through the sidewall and in communication with the pool reservoir;
an outlet valve extending through the sidewall an in communication with the pool reservoir;
the inlet valve and the outlet valve being operable in concert with each other to achieve a prescribed circulation through the pool reservoir.

14. The inflatable pool recited in claim 13, wherein the sidewall includes:
an outer panel;
an inner panel;
a first panel having an outer edge coupled to the outer panel and an inner edge coupled to the inner panel; and
a second panel having an outer edge coupled to the outer panel adjacent the outer edge of the first panel, and an inner edge coupled to the inner panel;
the first and second panels being selectively transitional between an open position and a closed position, in the open position, the outer edges of the first and second panels being moved closer together as the first and second panels transition from the open position toward the closed position.

15. The inflatable pool recited in claim 14, wherein the outer edges of the first and second panels are spaced apart by 3-8 cm when the first and second panels are in the open position.

16. The inflatable pool recited in claim 13, wherein the floor panel includes a pad formed of a polymer material.

17. The inflatable pool recited in claim 13, wherein the sidewall is configured to have a pair of opposed arcuate end portions when in the inflated configuration.

18. A method of forming an inflatable pool, the method comprising the steps of:
forming at least two voids in a panel assembly including:
an inner panel;
an outer panel opposite the inner panel and defining an enclosure therebetween; and
a plurality of threads, each thread being connected to the inner panel and the outer panel;
each void being formed at least in the inner panel;
integrating an inflation valve extending into the panel assembly;
integrating at least one valve extending through the panel assembly; and
forming the panel assembly into a sidewall having a pair of straight portions and a pair of opposing rounded portions, each rounded portion being formed by closing one of the at least two voids, the sidewall being inflatable and configured to transition between a deflated configuration and an inflated configuration, the volume of the enclosure increasing as the sidewall transitions from the deflated configuration toward the inflated configuration.

19. The method recited in claim 18, further comprising the step of applying a connecting strip to the panel assembly after the void has been closed, the connecting strip extending over the collapsed void to mitigate opening of the void.

20. The method recited in claim 18, further comprising the step of connecting a floor panel to the sidewall.

21. A kit including the inflatable pool recited in claim 1, the kit further including a storage bag sized to receive the inflatable pool when the inflatable wall is in the deflated configuration.

22. The kit recited in claim 21, further comprising a pump fluidly connectable to the inflatable wall and configured to pump air into the inflatable wall to transition the inflatable wall from the deflated configuration toward the inflated configuration.
